(19) United States
(12) Patent Application Publication
(10) Pub. No.: US 2009/0295056 A1
(43) Pub. Date: Dec. 3, 2009

(54) JIG

(75) Inventor: Philip Bunce, Victoria (AU)

Correspondence Address: MERCHANT & GOULD PC, P.O. BOX 2903, MINNEAPOLIS, MN, 55402-0903, US

(73) Assignee: Eastland Medical Systems Ltd., West Perth (AU)

(21) Appl. No.: 11/813,322

(22) PCT Filed: Jan. 6, 2006
(86) PCT No.: PCT/AU06/00015

§ 371 Date: Feb. 13, 2009

(30) Foreign Application Priority Data
Jan. 7, 2005 (AU) 200590055

(51) Int. Cl. B23Q 3/06

(52) U.S. Cl. 269/288

(57) ABSTRACT

A jig intended to in use hold a set of blanks (11) during machining of the blanks where the blanks have a rod-like portion, the jig having a body adapted to be mounted to a drive shaft to cause rotation of the body about an axis of rotation, the body having an outer portion (15) and an inner portion (17) wherein the outer and inner portions are capable of angular displacement relative to each other, the portions having opposed faces which are concentric and define clamping faces which in use are intended to support the rod-like portions of a set of blanks such that their central axes are substantially parallel to the axis of rotation and at least one end extends axially beyond the body, the drive member shaft being capable of causing relative angular displacement between the outer portion and the inner portion and causing the joint rotation of the jig about the central axis.

### FIELD OF THE INVENTION

This invention relates to the manufacture of elongate elements which require treatment such as machining, grinding and like treatment. Such elongate items can include hypodermic needles and other small diameter components such as trephines or trocars or more particular to the machining of hypodermic needles and other small diameter components. However the invention also has application to machining of large diameter elongate elements which can comprise machine parts.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

Accordingly the invention resides in a jig intended to in use hold a set of blanks during machining of the blanks, said blanks having a rod-like portion, said jig having a body adapted to be mounted to a drive shaft for rotation of the body about an axis of rotation, the body having an outer portion and an inner portion wherein the outer and inner portions are capable of angular displacement relative to each other, the portions having opposed faces which are concentric and define clamping faces which in use are intended to support the rod-like portions of a set of blanks such that their central axes are substantially parallel to the axis of rotation and at least one end extends axially beyond the body, the drive shaft being capable of causing relative angular displacement between the outer portion and the inner portion and causing the joint rotation of the jig about the central axis.

According to a preferred feature of the invention the inner portion comprises a circular outer face and the outer portion comprises a flexible element receivable over the circular outer face to occupy a clamping position which is in close face to face engagement with the circular outer face, said flexible element being displaceable towards and away from the circular outer face between the clamping position and a non-clamping positions respectively. According to a preferred feature of the invention the flexible element has the form of a band. According to a preferred feature of the invention the flexible element has two ends.

According to a preferred feature of the invention, said drive member comprises a hub rotatably supported within the inner portion about an axis which is concentric to the circular outer surface, the hub being capable of relative angular movement relative to the inner portion the outer portion being supported from the hub, the hub and inner portion being capable of said joint rotation. According to a preferred feature of the invention the circular outer surface has an opening and the hub has a radial extension which is accessible through the opening, the opening being dimensioned to allow a degree of relative angular movement of the radial with respect to the inner portion, the ends of the flexible element being fixed to the radial extension, an engagement member supported from the hub and being accessible through the opening, the engagement member being engagable with the an end of the flexible element to cause relative angular displacement between the ends to cause the flexible element to be displaceable between a the clamping and non-clamping positions. According to a preferred feature of the invention the flexible element comprises a plurality of portions which jointly surround the circular outer face. According to a preferred feature of the invention each portion is associated with an opening in the outer circular face and a radial extension wherein the radial extension at each opening engages the ends of the portions which are proximate the opening and the respective engagement member engages the an end of one of the portions which is proximate the opening.

According to a preferred feature of the invention the blanks comprise needle blanks.

The invention will be more fully understood in the light of the following description of several specific embodiments.

### BRIEF DESCRIPTION OF THE DRAWINGS

The description is made with reference to the accompanying drawing of which:

FIG. 1 is a schematic sectional cross sectional view of a jig according to a first embodiment showing the flexible element in the clamped position;

FIG. 2 is a sectional side cross section of the first embodiment showing the flexible element in the displaced position;

FIG. 3 is an enlarged part sectional view of the jig of the first embodiment showing the inter-engagement of the radial extension and the engagement member with the flexible element both in the clamped position and in the expanded position;

FIG. 4 is an enlarged section view of the jig of the first embodiment showing the engagement of elongate members between the flexible element and the circular outer face; and

FIG. 5 is a part sectional side elevation illustrating the engagement of the blanks between the clamping surfaces.

### DETAILED DESCRIPTION OF SPECIFIC EMBODIMENTS

The first embodiment as shown in the drawings comprises a jig which can be utilised for supporting blanks 11 which are to be used as the needles of hypodermic syringes. The jig serves to support the blanks to enable one or both ends to be machined by a grinding action to form the desired facet or facets at the respective end of the all of the needle blanks in the one action. The jig is a development of the rotary jig which is the subject of WO2004/065036.

The jig comprises an outer flexible element which is defined by a flexible band 13 and an inner portion 15 comprising an annular member which presents an outer circular face in opposed relation to the band 13. In addition the band 13 is associated with a central hub 17 which is accommodated within the inner portion 15 to be capable of rotation within the inner portion such that the hub is capable of angular displacement relative to the inner portion 14 about the central axis X of both the jig and inner portion. The central hub 17 is formed with a radial extension 19 which extends through an opening 21 provided in the inner member 15. The dimensions of the opening 21 allow for relative angular displacement of the radial member 19 within the opening 21 as a result of relative angular displacement between the central hub 17 and the inner portion 15.

In addition the inner portion 15 is provided with a set of three locking recesses 25 which are intended to be engaged by a set of locking elements (not shown) provided on the drive head (not shown) which is intended to support the jig from the rotatable head of a grinding machine.

The drive head with which the jig us to be used comprises a dual drive whereby one drive engages the central hub 17 and the other (which incorporates the locking members) engages the inner portion 15 through the locking members being lockingly received in the locking recesses. Each of the drives are capable of relative angular displacement with respect of each other to cause corresponding movement relative angular displacement between the central hub 17 and the inner portion 15. In addition each of the drives are jointly rotatable about a central axis which is coaxial with the central axis X of the jig to cause bodily rotation of the jig about the central axis with the inner portion and hub being relatively stationary with respect to each other.

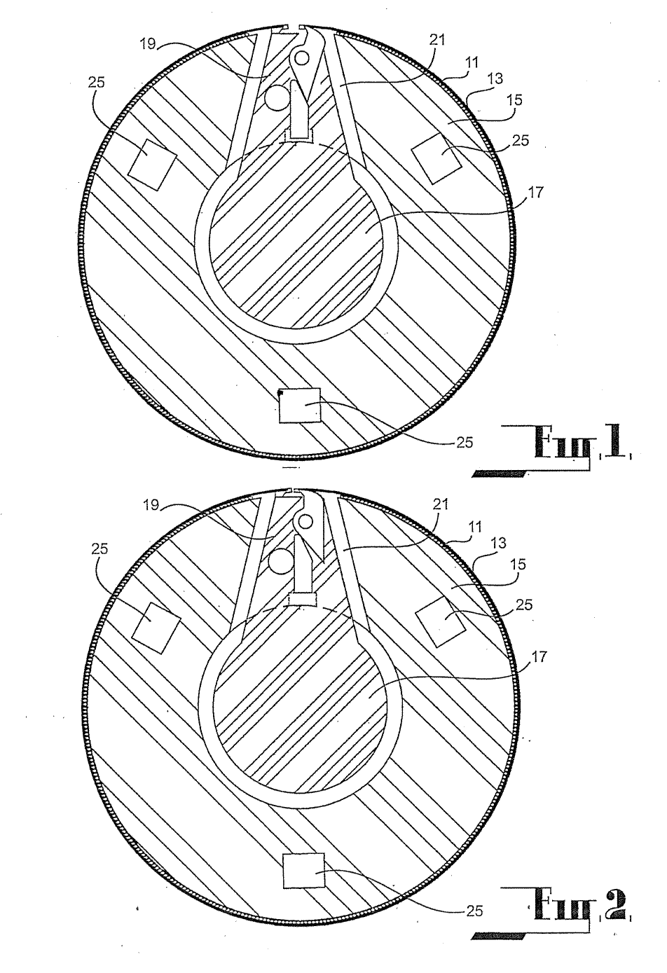

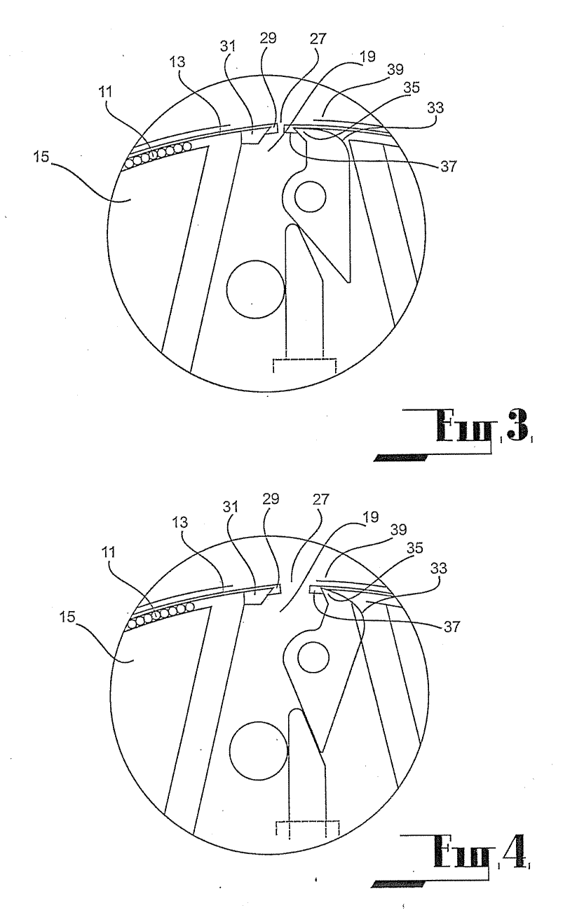

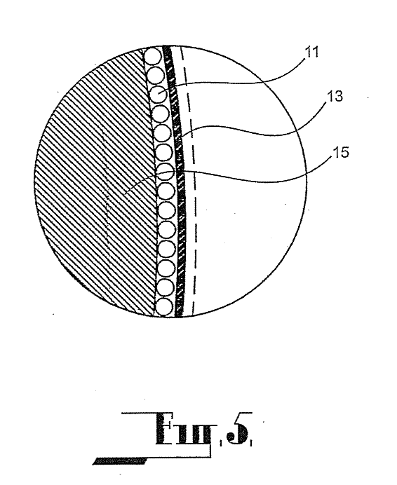

The band 13 is supported from the jig through the radial extension 21. In this regard one end 27 of the band 13 is engaged with the outer end of the radial extension 19. As shown at FIGS. 3 and 4 the engagement is effected by means of a first barbed shaped rib 29 at the one end 27 which engages a correspondingly shaped fixed pawl member 31 provided at the outer end of the radial extension 19. In addition the radial extension 19 supports a clamping member 33 which is pivotally supported upon the radial extension 19 about an axis which is parallel to the central axis X. The clamping member 33 and is provided at its outer end with a tooth 35 which engages with a second barbed rib 37 provided at the other end 39 of the band. The clamping member is driven by a suitable mechanism to be movable between a clamping position at which the tooth 35 is in close engagement with the radial extension 19 as shown in FIG. 1 and in solid lines in FIG. 3 and its retracted position as shown in FIG. 2 and in broken lines at FIG. 3. When the tooth is engaged with the second barbed rib 37 of the other end of the band, with the movement of the clamping member 33 between its end position as shown at FIGS. 1 and 2 the band is caused to be moved from clamped position at which it is in engagement with the needle blanks which are supported from the circular outer face of the inner portion 15 as shown at FIG. 1 and the displaced position at which is out of clamping engagement with the needle blanks which are supported from the circular outer face as shown at FIG. 2.

When the band is in its clamping position the needle blanks 11 are held in tight clamped engagement between the circular face and the band to be substantially incapable of any relative movement. This will facilitate the grinding of the free ends of the blanks on rotation of the jig about the central axis X. When it becomes necessary to grind another facet onto the respective end of the element of the blanks the central hub 17 is displaced angularly relative to the inner portion 15. Such angular displacement causes relative displacement of the band 13 over the outer circular face of the inner portion 15 and rotation of the needle blanks which are supported there-between about their central axes. As a result an additional facet can be formed on the respective end.

In order to load a jig according to the embodiment the jig is removed from a drive head and is located at a loading station at which position the clamping member is released which enables the band 11 to be disengaged from the angular portion 15. Once the band has been removed from the inner portion 15 the needle blanks can then be applied to the jig when the jig is to be loaded or in the event of a full jig having been delivered to the station the needle blanks can be removed.

According to one embodiment the circular outer face of the inner portion is magnetised with magnets, which take the form of rare earth magnets which have a very high magnetic field strength and which are supported at around the circular outer face. The presence of a strong magnetic filed on the circular outer face serves to retain the needle blanks in position on the circular outer face. Although it is generally believed that stainless steel of which the needle blanks are formed has little or no magnetic properties, it has been found that when subjected to a high magnetic fields as available with rare earth magnets there is a degree of magnetic attraction and such attraction forces which are sufficient to retain the needle blanks in position on the outer surface during loading and unloading of needle blanks from the jig.

According to another embodiment of the invention the needle blanks are retained on the circular outer face by means of an adherent such a gel which is able to hold the needle blanks in position and is able to washed from the finished needles.

According to a further embodiment of the invention the one end 27 of the band is permanently fixed to the outer end of the radial extension 19 through a hinge like connection which enables the band to be permanently supported from the jig throughout the loading and unloading function but prevents any undue flexing of the flexible band when being moved between its clamped and displaced position.

According to a further embodiment of the invention the band is formed of a pair of portions which jointly surround the inner portion 15. In the case of a further embodiment the central hub supports a pair of diametrically opposed radial extensions which engage the respective one end and other end of the portions.

The embodiments each provide a means whereby needle blanks can be supported around almost the entire periphery of a circular member and are held in positive engagement by the application of a clamping force applied at one position around the surface of the member. Furthermore the needle blanks can be caused to rotate about their central axes to facilitate the formation of a plurality of facets at the ends of the needles.

It should be appreciated that the scope of the present invention may not be limited to the particular scope of the embodiments described above. In particular it should be noted that the scope of the invention need not be limited to use with needle blanks but can in fact be used in the machining of the forming of components having a rod-like portion which is receivable between the clamping surfaces.

1. A jig intended to in use hold a set of blanks during machining of the blanks, said blanks having a rod-like portion, said jig having a body adapted to be mounted to a drive shaft for rotation of the body about an axis of rotation, the body having an outer portion and an inner portion wherein the outer and inner portions are capable of angular displacement relative to each other, the portions having opposed faces which are concentric and define clamping faces which in use are intended to support the rod-like portions of a set of blanks such that their central axes are substantially parallel to the axis of rotation and at least one end extends axially beyond the body, the drive shaft being capable of causing relative angular displacement between the outer portion and the inner portion and causing the joint rotation of the jig about the central axis.

2. A jig as claimed at claim 1 wherein the inner portion comprises a circular outer face and the outer portion comprises a flexible element receivable over the circular outer face to occupy a clamping position which is in close face to face engagement with the circular outer face, said flexible element being displaceable towards and away from the circular outer face between the clamping position and a non-clamping positions respectively.

3. A jig as claimed at claim 2 wherein the flexible element has the form of a band.

4. A jig as claimed at claim 2 wherein the flexible element has two ends.

5. A jig as claimed at claim 2 wherein, said drive member comprises a hub rotatably supported within the inner portion about an axis which is concentric to the circular outer surface, the hub being capable of relative angular movement relative to the inner portion the outer portion being supported from the hub, the hub and inner portion being capable of said joint rotation.

6. A jig as claimed at claim 5, wherein the circular outer surface has an opening and the hub has a radial extension which is accessible through the opening, the opening being dimensioned to allow a degree of relative angular movement of the radial with respect to the inner portion, the ends of the flexible element being fixed to the radial extension, an engagement member supported from the hub and being accessible through the opening, the engagement member being engagable with the an end of the flexible element to cause relative angular displacement between the ends to cause the flexible element to be displaceable between a the clamping and non-clamping positions.

7. A jig as claimed at claim 6 wherein the flexible element comprises a plurality of portions which jointly surround the circular outer face.

8. A jig as claimed at claim 7 wherein each portion is associated with an opening in the outer circular face and a radial extension wherein the radial extension at each opening engages the ends of the portions which are proximate the opening and the respective engagement member engages the an end of one of the portions which is proximate the opening.

9. A jig as claimed at claim 1 wherein the blanks comprise needle blanks.

10. (canceled)
